(19) United States
(12) Patent Application Publication
(10) Pub. No.: US 2026/0025063 A1
(43) Pub. Date: Jan. 22, 2026

(54) METHOD FOR COMMISSIONING AN ELECTRICAL POWER CONVERSION SYSTEM AND ELECTRICAL POWER CONVERSION SYSTEM

(71) Applicant: SMA Solar Technology AG, Niestetal (DE)

(72) Inventor: Marcus Erbert, Fuldatal (DE)

(21) Appl. No.: 19/339,479

(22) Filed: Sep. 25, 2025

Related U.S. Application Data
(63) Continuation of application No. PCT/EP2024/057849, filed on Mar. 22, 2024.

(30) Foreign Application Priority Data
Mar. 27, 2023 (DE) 10 2023 107 651.5

(51) Int. Cl. H02M 1/32; H02M 7/537

(52) U.S. Cl. CPC H02M 1/32; H02M 7/537

(57) ABSTRACT

A system and method for electrical power conversion is disclosed. The system includes at least one power converter with an intermediate circuit and a bridge circuit, and is connected on a DC side to at least one DC unit, and on an AC side to an AC grid. The at least one power converter can be connected to the at least one DC unit by means of at least one DC switch and to the AC grid by means of at least one AC switch. The method includes the formation of an auxiliary network for supplying power to system components; connecting to the AC grid without connecting to the at least one DC unit; and a connecting the AC grid and the at least one connected DC generator to facilitate a power exchange between the AC grid and the at least one DC unit.

### REFERENCE TO RELATED APPLICATIONS

This application is a Continuation of International Application number PCT/EP2024/057849, filed on Mar. 22, 2024, which claims the benefit of German Application number 10 2023 107 651.5, filed on Mar. 27, 2023. The contents of the above-referenced Patent Applications are hereby incorporated by reference in their entirety.

### FIELD

The application relates to a method for commissioning a system for electrical power conversion, in particular a large-scale electrical system, e.g., from approximately 1 MW. The application further relates to a system for electrical power conversion, in particular a large-scale electrical system, e.g., from approximately 1 MW.

### BACKGROUND

The commissioning of a system for electrical power conversion having a power converter that comprises at least one power electronic bridge circuit may involve, for example, switching on the system in a normal mode. Switching on the system in the normal mode may, for example, cause the system to operate at its rated power, provided such power is available. In the case of a photovoltaic generator (PV generator) as the energy source of the system, the system may be configured in the normal mode to maximize the output of the PV generator. In the case of a load, such as an electrolyzer serving as a DC unit on the power converter, the system may be configured in the normal mode to supply the electrolyzer with a rated power.

During operation of the system's power converter, faults may occur that result in a failure of the power converter and/or a damaging of the individual components thereof. For power converters in systems rated at approximately 1 MW or higher, such failures of power converters and/or components of the power converter can result in costs amounting to, for example, several tens of thousands of euros per fault event.

Fault analyses of failed components indicate that faults in components of the power converter occur during commissioning or shortly thereafter. Although power converters can generally be repaired, repair of a serious fault, for example, in a power electronic bridge circuit of the power converter, may not be possible at the installation site of the power converter. This results in higher costs and greater effort due to the need to transport the power converter and/or other parts of the system. In the case of large-scale systems, the effort and costs for repair are particularly high due to the physical size of the power converter.

### SUMMARY

The application addresses the problem of providing a method and a system with improved commissioning, such that damage to a power converter of the system is prevented during subsequent normal operation.

A system for electrical power conversion comprises at least one power converter with an intermediate circuit and a bridge circuit. The power converter can, for example, be an inverter that can convert electrical power from AC (alternating current) to DC (direct current) and/or vice versa. The system is connected on a DC side to at least one DC unit, for example, a DC generator, and on an AC side to an AC grid, wherein the at least one power converter can be connected to the DC unit by means of at least one DC switch and to the AC grid by means of at least one AC switch.

A method for commissioning such a system comprises:
A) a first phase, which comprises establishing an auxiliary network for supplying power to components of the system,
B) a second phase with a temporarily connected AC grid without connection to the at least one DC unit, and
C) a third phase with a connected AC grid and at least one connected DC unit.

Phase A of the method may, for example, include receiving an input from an operator of the system. Such an input may, for example, trigger the start of the method. Alternatively, the method can also start automatically. The operator's input may also, for example, confirm the end of phase A and thus trigger the start of phase B.

The DC units may comprise, for example, photovoltaic generators, batteries and/or electrolyzers and the like.

The auxiliary network may, for example, be a DC auxiliary network with a voltage of, for example, 12 volts, 15 volts, or 24 volts. The DC auxiliary network may, for example, be supplied from the AC grid via a rectifier in the system. Alternatively or additionally, the DC auxiliary network may be supplied with electrical power from an external source.

Phases A, B, and C of the method can also be referred to as commissioning phases or test phases, in which different states of the system are specifically established in order to be able to prepare and/or test the functioning of components of the system separately from one another as part of the commissioning process. In this way, proper functioning of the system in normal mode following commissioning can be ensured or troubleshooting can also be supported.

In one embodiment, the phases of the commissioning method are at least partially automated and serve to slowly power up the system in order to avoid or limit serious and/or costly damage to the system, for example, to the system's power converter. The method phases are selected to minimize damage in the event of a fault. This has an advantage that bridge circuits of the power converter, which comprise, for example, power modules with semiconductor power switches, for example, IGBT modules, are slowly powered up by the method, so that early failures in the bridge circuit can be avoided or detected immediately. If faults occur in the plant's power path, the slow power-up minimizes or, if possible, prevents costly secondary damage.

In addition, the step-by-step commissioning procedure enables improved temporal and/or spatial localization of any fault, since the activities and resulting effects of the individual steps carried out during commissioning are known. This allows for traceability of what was tested and what happened.

The electrical power conversion system comprises a control unit or circuit which is designed and configured to carry out the acts or steps of the individual phases of the described method. The control unit or circuit may, for example, be located in the power converter of the system and may also be responsible for controlling the power switches of the bridge circuit of the power converter.

In one embodiment of the method, the power converter of the system can be put into a commissioning mode at the end of production, such that the power converter starts directly and exclusively in commissioning mode when switched on for the first time. This may mean, for example, that the power converter's control unit automatically executes the described commissioning method when the power converter is first powered up.

The step-by-step commissioning process described above can, for example, also reduce secondary damage to the system. Through the controlled step-by-step powering-up of the at least one power converter, it is possible to detect early on whether a power component, e.g., a power semiconductor switch of the bridge circuit, is damaged. Any resulting short-circuit currents, for example on the DC side of the power converter with DC units connected to it, such as batteries, can be prevented from subsequently triggering DC fuses, which would then have to be replaced, for example. In addition, it can be prevented that a fault in, for example, one of multiple bridges connected in parallel in the bridge circuit can spread to the neighboring bridges and cause subsequent damage there, for example through unwanted circulating currents.

The commissioning method can therefore protect, for example, the hardware components of at least one power converter of the system and reduce or prevent secondary faults. This could reduce the costs caused by secondary faults. The method can be automatic or at least partially automatic. A person responsible for commissioning, e.g., a system operator, can be supported by the automatic or semi-automatic process during commissioning. Aborting the method in the event of a fault can enable guided troubleshooting for the operator.

In one embodiment of the method, phase A comprises:
establishing the auxiliary network for supplying power to components of the system from the AC grid via a rectifier of the system, in particular for powering the actuation of the AC switch, the DC switches, and a sine filter capacitor contactor,
closing the AC switch,
connecting a capacitor of an AC-side sine filter to the AC grid, in particular via the sine filter capacitor contactor,
checking the power supply from the auxiliary network and subsequently opening the AC switch, and
continuing the method if the power supply from the auxiliary network is within predetermined limits or aborting the method if the power supply from the auxiliary network is outside the predetermined limits.

In addition, individual or all steps of phase A can optionally be acknowledged by the system operator via an input.

The predetermined limits of the power supply from the auxiliary network can, for example, be permissible limits within which the system can be operated safely. The limits can be specified, for example, via the system's control unit or circuit, or by the system operator.

As a result of establishing the auxiliary network, it is possible in phase A to initially carry out stepwise checking of the components that are supplied with electrical energy by the auxiliary network, e.g., switching elements of the system. In addition, the stability of the auxiliary network can be tested during pre-charging processes, such as the pre-charging of a sine filter capacitor.

In one embodiment of the method, phase B comprises:
pre-charging the DC intermediate circuit via a pre-charging circuit,
performing a self-test of the power converter's bridge circuit,
if the self-test is successful: connecting the AC grid by closing the at least one AC switch.

This allows faults in the power electronics of the bridge circuit to be detected at an early stage and subsequent faults to be prevented. For example, the switches of the bridge circuit can be tested under essentially no-load conditions with regard to their basic switching function and their dielectric strength. Only then is the AC grid switched on. The AC grid is therefore only temporarily connected to the bridge circuit during phase B.

In one embodiment of the method, phase B comprises:
with the AC grid connected: controlled switching of the bridge circuit of the at least one power converter to exchange electrical reactive power, in particular inductive reactive power, between the intermediate circuit and the AC grid.

Through the exchange of reactive power, the temperature of at least one power converter can be controlled. During this phase, the system, for example, the at least one power converter can be brought into the temperature range for which it is designed for later operation. In this way, for example, semiconductor components of the at least one power converter can be brought into a temperature range corresponding to an operating temperature during normal operation of the power converter, enabling the semiconductor switches to operate efficiently and with a good service life.

In one embodiment of the method, a temperature in the power converter, for example, in a bridge circuit of the power converter, is detected and increased by adjusting the reactive power exchange and/or controlling a fan of the system, until the temperature in the power converter exceeds a predetermined lower threshold and/or reaches a predetermined upper threshold. For example, the temperature increase is carried out until the temperature in the power converter is within a predetermined range, which can be, for example, between the lower threshold and the upper threshold.

In one embodiment of the method, the lower and upper thresholds exhibit a temperature difference of at least 40 Kelvin, or at least 60 Kelvin. The temperature in the power converter, for example, in a bridge circuit of the power converter, is adjusted by controlling the reactive power exchange and/or by controlling the fan such that the lower and upper thresholds are repeatedly reached in alternation.

Through these planned temperature lifts, temperature effects of repeated warming up and cooling down can be used in preparation for later operation.

In one embodiment of the method, phase C comprises:
with the AC grid connected and with at least one connected DC unit:
exchanging power between the AC side and the DC side, detecting an exchanged AC power and an exchanged DC power of the at least one power converter, and checking the plausibility of the detected power values. The power exchange can take place particularly at low power levels, in particular at a power level of between 5% and 20% of the rated power of the at least one power converter.

In one embodiment of the method, phase C comprises:
with the AC grid connected and with several DC units connected in parallel on the DC side:
detecting currents of the DC units connected in parallel and checking the symmetry of the detected currents. For example, the individual currents of the individual DC units of the parallel circuit can be detected and the symmetry of the detected currents can be checked.

Optionally, voltages can also be detected. Using the detected voltages and currents, it is possible by comparing them with predetermined reference values to determine whether the DC units connected to the system, e.g., photovoltaic generators, batteries or loads such as electrolyzers, are functioning as intended. The predeterminable comparison values may, for example, be stored in a control unit or circuit of the system and/or entered by an operator via an interface.

Detection of the individual currents can be carried out particularly at a low power level of the DC units, e.g., at a minimum power level of an electrolyzer. Even or especially at low power levels, it is possible to detect a malfunction of the system by detecting the currents and/or voltages.

In one embodiment of the method, phase C further comprises:
checking the fan and/or other sensors in the system.

In one embodiment of the method, phase C further comprises:
with the AC grid connected and with at least one connected DC unit:
exchanging power between the AC side and the DC side, with the power exchange being increased in several stages.

This allows at least one power converter to be gradually powered up and gradually subjected to greater load. In the event of a fault, the method can be aborted, and the level of loading at which the fault occurred may provide an indication of the cause thereof.

In this context, the power exchange between the AC side and the DC side can be increased in several stages between approximately 10% of the rated power of the system and approximately 60% of the rated power of the system. If there is exactly one power converter in the system, the rated power of the system can correspond to the rated power of the power converter. If the system comprises multiple power converters, the rated power of the system can correspond to the sum of the rated powers of the plurality of power converters.

In one embodiment of the method, phase C further comprises:
when at least one predeterminable temperature of the at least one power converter is reached for a predetermined period of time: terminating the method for commissioning and starting normal operation of the system.

In one embodiment, the system comprises the sine filter capacitor contactor for switching on or connecting the sine filter capacitor to the AC grid. The sine filter capacitor contactor, for example, has an electrical actuator that is powered by the auxiliary network. This allows the functioning of the contactor to be tested and assessed in phase A of the method.

In one embodiment, the system comprises the auxiliary network with an auxiliary network disconnector for connecting the auxiliary network to the AC grid, wherein the sine filter capacitor contactor can be functionally coupled to the auxiliary network disconnector.

This can be used, for example, to reduce potential disturbances to the auxiliary network when connecting the sine filter capacitor to the AC grid and, in particular, to prevent overvoltages in the auxiliary network. This enables a secure power supply to the system components via the auxiliary network, even if large currents temporarily flow between the sine filter capacitor and the AC grid.

In one embodiment of the system, the auxiliary network comprises a rectifier that provides a DC auxiliary voltage, wherein the functional coupling between the sine filter capacitor contactor and the auxiliary network disconnector is configured to maintain the DC auxiliary voltage at a predetermined quality level when the sine filter capacitor contactor is actuated. This may, for example, mean maintaining the voltage of the auxiliary network within a tolerance range around a nominal voltage of, for example, 24 V. This allows the components supplied with electrical power by the auxiliary network to be protected from voltage fluctuations in the auxiliary network.

The effect on the auxiliary network of a connection with power exchange between the sine filter capacitor and the AC grid can also be tested and assessed in phase A of the method. In phase A, the functioning of the functional coupling between the sine filter capacitor contactor and the auxiliary network disconnector can then be checked. This is particularly relevant in one embodiment when electrically pre-charging the sine filter capacitor via the AC grid.

### BRIEF DESCRIPTION OF THE FIGURES

The disclosure is further explained and described below with reference to example embodiments illustrated in the figures.

FIG. 1 shows a schematic flow of a method according to one embodiment.

FIG. 2 shows a schematic diagram of a system for electrical power conversion according to one embodiment.

FIG. 3 shows a schematic diagram of the influence of temperature in an electrical power conversion system.

### DETAILED DESCRIPTION

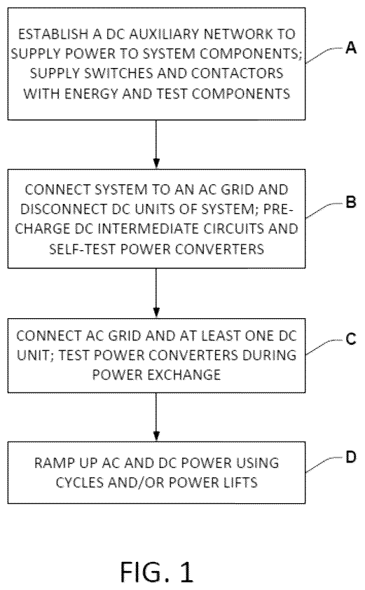

FIG. 1 shows a schematic flow of the method with acts or phases A, B and C. In phases A, B, C, also called stages, specific states of a system 10 are established, which allow the functioning of individual components of the system to be checked and/or prepared. The sequence of states and the components involved are selected in such a way that any faults that occur have the least possible consequences and results in the least possible or no subsequent faults.

In the first act or phase A, an auxiliary network 36, for example, a DC auxiliary network, is established to supply power to components of the system 10. Further acts of phase A are carried out once the auxiliary network 36 has been established.

In one embodiment, phase A may further comprise supplying electrically controllable switching devices, such as switches and contactors, with energy via the auxiliary network 36. In act or phase A, the functioning of the switches, for example, an AC switch 20, DC switches 18, and a sine filter capacitor contactor 30, may also be tested.

The acts of the second phase B comprise temporarily connecting the system 10 to an AC grid 14. During the acts of phase B, the connection to DC units of system 10 is disconnected.

In act or phase B, the DC intermediate circuits of the power converters 16 of the system 10 can initially be pre-charged via a pre-charging circuit 22 according to one embodiment. A self-test of the power converters 16 can then follow, while the AC grid 14 is disconnected. After a successful self-test, semiconductor switches of each bridge circuit of the power converters 16 can then be preheated by exchanging reactive power with the AC grid 14, i.e., their temperature can be brought to a predeterminable range, wherein the range is, in one embodiment, a temperature range that corresponds to usual operating temperatures in normal operation and/or in which the semiconductor switches exhibit good efficiency and/or long durability.

The acts of phase C are carried out with the AC grid 14 connected and at least one DC unit connected, e.g., with a DC generator 12 connected.

In act or phase C, the system 10, for example, the power converters 16 can be tested during a power exchange between their respective AC sides and DC sides. For example, currents and/or voltages can be detected and checked for plausibility by comparing them with predeterminable values.

Act or phase D is used to commission system 10 with AC and DC power, in which the power is gradually ramped up. Cycles and power lifts are provided for this purpose.

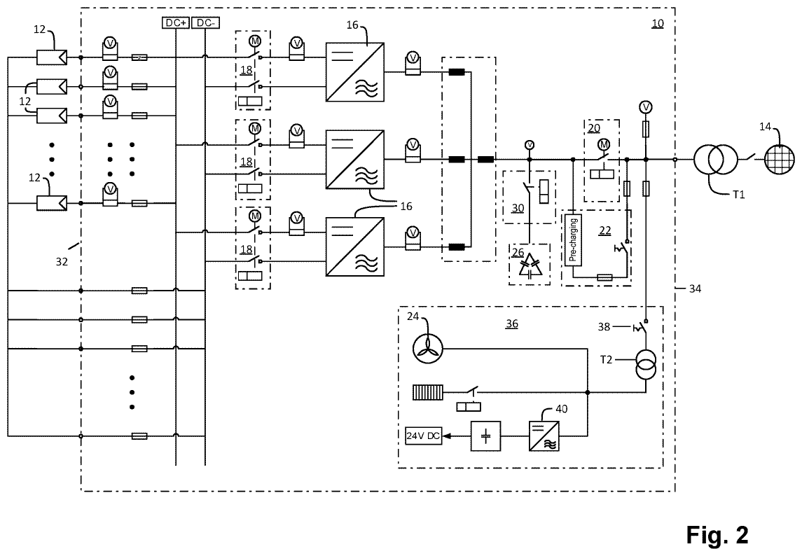

FIG. 2 shows one embodiment of the system 10 for electrical power conversion. The system 10 in this context comprises the power converters 16, which are connected to a DC bus via the DC switches 18. The DC bus provides a DC-side connection between the power converter 16 and the DC side 32 of system 10. DC units, e.g., DC generators 12 as energy sources and/or batteries (not shown) as energy storage devices and/or loads (not shown) such as electrolyzers can be connected to the DC side 32 of the system 10. On the AC side, the power converters 16 are connected to the AC grid via the AC switch 20. On the AC side 34, the system 10 can be connected to the AC grid 14 via a first transformer T1.

The auxiliary network 36 can be connected to the AC side of the system 10 via an auxiliary network disconnector 38 and a second transformer T2, thus drawing electrical power from the AC grid 14. Components of the system 10, e.g., fan 24, heating and/or switching elements of the system 10, can be supplied with electrical energy via the auxiliary network 36.

FIG. 2 illustrates a possible sequence of the method for commissioning system 10 in more detail.

Act or phase A is primarily intended for the commissioning and testing of the self-supply of system 10 with electrical energy via the auxiliary network 36. The auxiliary network 36 may also be referred to as the onboard power supply and comprises, for example, a DC network, e.g., a 24V DC network.

The auxiliary network 36 of the system 10 can be supplied from the AC grid 14, to which the power section of the power converter 16 is connected on the AC side. Alternatively or additionally, the auxiliary network 36 may be supplied by an external electrical source that is independent of this AC grid 14, for example, from a separate low-voltage network that is constructed independently of the AC grid 14. In both cases, an alternating voltage is converted into a direct voltage by means of a rectifier 40 in order to supply a DC portion of the auxiliary network 36.

In act or phase A, it should be ensured that both the external DC units and the external AC grid 14 are disconnected from the power converters 16. This can be done, for example, by a qualified person, such as an operator of system 10 or a service technician via the DC switches 18 and the AC switch 20, respectively.

In the next acts of phase A, the switching elements of system 10, e.g., the DC switches 18, the AC switch 20 and/or the sine filter capacitor contactor 30, can be gradually put into operation and tested.

For this purpose, in one embodiment the DC switches 18 are first switched on and off several times. Each DC switch 18 is switched individually in this process, for example. In one embodiment, after all DC switches 18 have been switched once, the switching process of each DC switch 18 is repeated twice more. In one embodiment, a wait time of approximately 2 minutes between each switching operation is employed. These switching operations can either be performed automatically by the method or manually.

Since the DC switches 18 are switched individually, it is possible, for example, for an operator, to detect if certain switches fail to operate. Alternatively or additionally, at least one DC switch 18 may comprise a self-diagnosis function and automatically issue a corresponding message. If a fault is detected during this phase, the method is aborted to avoid subsequent damage to system 10.

In the next act of phase A, the AC switch 20 is switched on and off twice according to one embodiment. A wait time of approximately 2 minutes between each switching operation is employed in one embodiment. These switching operations can either be performed automatically by the method or manually.

In one embodiment, in the next act of phase A, the sine filter capacitor contactor 30 is switched on and off twice. These switching operations can either be performed automatically by the method or manually. Optionally, in one embodiment the sine filter capacitor 26 can be pre-charged via a suitable pre-charging circuit.

If the sine filter capacitor contactor 30 is switched on when the AC switch 20 is closed, i.e., while there is an active connection to the AC grid 14, significant compensating currents may arise due to possible voltage differences between the sine filter capacitor 26 and the grid voltage, in order to equalize the voltage between the sine filter capacitor 26 and the AC grid 14. This can lead to a significant fluctuation in the input voltage of the auxiliary network 36, which in turn can result in a failure of the auxiliary network 36, for example, a shutdown of the rectifier 40. Therefore, the sine filter capacitor contactor 30 and the auxiliary network disconnector 38 are coupled in such a way that switching on the voltage of the sine filter capacitor contactor 30 causes the auxiliary network disconnector 38 to briefly switch off. This means that when the sine filter capacitor contactor 30 is actuated, the auxiliary network 36 is briefly disconnected from the AC side 34 of the system 10 by means of the auxiliary network disconnector 38 being opened. This disconnection ensures that any voltage fluctuation caused by the compensating currents towards the sine filter capacitor 26 does not affect the auxiliary network 36. The auxiliary network 36 itself can bridge such an interruption for a short period of time, approximately a few seconds, for example, approximately one second, wherein a 24 V DC network can be maintained by means of a buffer capacitor. The 24 V DC network can be used, for example, to control the switching elements of the system 10, such as DC switches 18, AC switches 20 and/or sine filter capacitor contactor 30.

In this respect, by test switching the sine filter capacitor contactor 30, it is possible to verify whether the power supply to the auxiliary network, e.g., its 24 V DC power supply, is reliably ensured, i.e., remains unaffected by the switching operations. Maintaining a target voltage, e.g., 24 V, may be used as an acceptance criterion.

After this verification of the self-supply, system 10 can automatically switch to act or phase B or—in the event of a fault—switch off and enter a safe state.

In act or phase A it is possible for a person, such as a service technician, to be on site. This person can observe and support phase A, and/or the switching devices can be operated manually in part. Act or phase A) can be acknowledged, for example, by an input from the person. If the test is aborted, it can be made clear, for example, at which point the test was interrupted. After appropriate repair, the method can then be restarted from the beginning with phase A.

Act or phase B serves to commission plant 10 with at least partial supply of AC power from the AC grid 14.

First, in act or phase B, a self-test of each bridge circuit, referred to as the stack, of the power converter 16 is carried out. The AC pre-charging circuit 22 pre-charges the DC intermediate circuit of the power converters 16. After the pre-charging has taken place, a self-test of the bridge circuit of the power converters 16 can be carried out without AC grid 14 and without DC unit.

The self-test can be performed once, for example. If the self-test is successful, the AC grid 14 can be connected by closing the AC switch 20.

In the next act of phase B, the power converters 16 of the system can be operated in the so-called Q@night mode, in which a reactive power exchange, for example, a pure reactive power exchange, takes place with the AC grid 14 while the DC switches 18 remain open.

The power converters 16 ramp up in the so-called Q@night mode. In this mode, each power converter 16 exchanges reactive power between the AC grid 14 and its intermediate circuit capacitance with appropriate controlling switching of its bridge circuit in order to heat the semiconductor power switches, which are configured, for example, as IGBT modules. In one embodiment, the DC voltage can be kept low during this process, especially to safely remove any residual moisture from the IGBT modules. For example, the DC voltage can be set slightly above the rectified value of the AC voltage so that the IGBT modules are minimally loaded with regard to any fault currents during the drying process.

Furthermore, heating, for example, cyclic heating, can trigger settlement mechanisms and reduce mechanical stresses that may have arisen during storage and transport of the system 10.

In addition, act or phase B can support the process of thermal paste distribution within the power converters 16, for example, between the IGBT modules in the bridge circuit and the respective associated heat sinks. The thermal paste distribution may not be complete at the time of commissioning. If this is the case, the IGBT modules are not yet fully efficient. For example, IGBT modules may have undefined cavities on the base plate that need to be filled with thermal paste. Thermal lifts are beneficial for this purpose, as they move each IGBT module in a manner similar to a pumping action, so that the thermal paste is pushed into the correct areas. The power converters 16 are thermally designed for a rated power and the dissipation of the resulting maximum power loss, assuming a defined heat dissipation during operation. This process is therefore advantageous in order to enable optimal distribution of the thermal paste and thus the expected heat dissipation.

It is advantageous in one embodiment to run at least 5 cycles with temperature lifts in order to optimally distribute the paste onto the heat sinks, e.g., the IGBT modules. After this process, improved thermal contact is achieved. This improvement in thermal contact can be achieved by thermally ramping up the power converters 16 in stages.

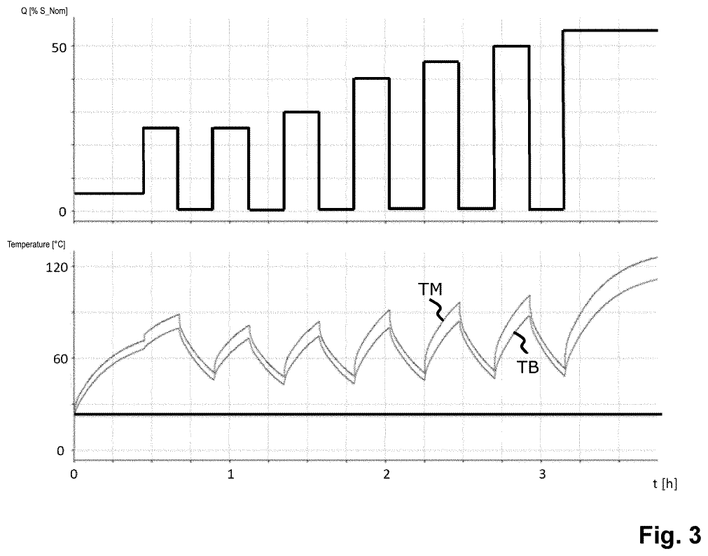

FIG. 3 shows an example of the curve of the reactive power Q exchanged via the bridge circuit of each power converter 16. In the upper diagram, the reactive power Q is shown as a fraction of the rated apparent power S_Nenn of each power converter 16. The lower diagram shows the progression of the resulting temperatures, measured at the bridge circuit in the IGBT module, temperature TM (larger value) and at the base plate, temperature TB (smaller value). The energy supply and the thermal cycles increase steadily, whereby several temperature cycles with temperature differences ranging from about 30 Kelvin at the beginning to over 60 Kelvin in the last cycle are achieved. Temperature cycles with temperature differences of approximately 60-70 Kelvin are particularly advantageous and can be achieved by extending the individual cycles accordingly and/or by increasing the reactive power in the heating phase and/or the cooling power, e.g., by the fan 14, in the cooling phase.

The reactive power setting and the control of the fan 24 can therefore be “temperature-controlled” accordingly. It may be advantageous to prioritize inductive reactive power Q if the power converter is connected via corresponding medium-voltage cables to an AC grid 14 which is designed as a medium-voltage grid.

Act or phase B may take longer than act or phase A. For example, act or phase B can run automatically at night. It is possible for act or phase B to be completed without any personnel being present at system 10. Once act or phase B is completed, the method can automatically transition to act or phase C.

If the test is aborted, it can be made clear, for example, at which point the test was interrupted. After any necessary repairs, the method can then be restarted from the beginning with either act or phase A, or act or phase B. In one embodiment, the method is repeated from the beginning, starting with act or phase A.

Act or phase C is used to commission the system 10 with AC and DC power, i.e., with the AC grid 14 connected and the DC units connected.

In the first act of phase C, plausibility checks are carried out with regard to various aspects of system 10. The plausibility checks can be carried out, for example, by determining measured values, e.g., currents and voltages, and comparing them with predeterminable test values. The test values can be stored in the control circuit of system 10 and/or entered by the operator.

First, the efficiency of each power converter 16 is checked for plausibility in one embodiment. At low power levels, the ratio of measured AC power to measured DC power is determined and checked. The check here comprises a comparison with a predeterminable test value within a tolerance range. If the measured ratio of AC power to DC power is outside the tolerance range, a fault has occurred. Possible causes include incorrect parameter settings of the power converter in question or a fault in the measuring equipment, e.g., measuring sensors. The aim of this test can be, for example, to check whether the parameters are set correctly and/or the measuring equipment is functioning properly. The efficiency check as such does not need to be carried out in this act.

In a next act of phase C, the DC current symmetry between several parallel DC inputs to which the DC units, for example, the DC generators, are connected can be checked.

In the case of parallel-connected and essentially similar DC generators 12, e.g., photovoltaic generators (PV generators), in one embodiment the DC currents at the parallel DC inputs can be determined automatically via the measuring equipment, assuming that the DC generators 12 are producing DC power. For example, if a power converter 16, which is a PV inverter with several DC generators 12 connected in parallel and configured as PV strings, shows an asymmetry in input currents, e.g., of the string currents, of more than 4%, this may indicate a defect in the connection setup, e.g., in the configuration of the PV strings. This deviation can then be corrected. This act of the method can be carried out, for example, at a minimum power level of between 10% and 30% of the rated power of the power converter 16, e.g., approximately 20%. At lower power levels, measurement inaccuracies may distort the comparison of the measured values.

In a further act, the thermal management of system 10 can be checked for plausibility. For example, it can be checked whether the fans are running according to the setpoint specifications and/or whether all temperature and humidity sensors are displaying a plausible value.

An optional self-test of the respective DC units, e.g., PV, battery, electrolyzer, can follow.

Act or phase C can, for example, be completed automatically. It is possible for act or phase C to be completed without any personnel being present at system 10 in one embodiment. Once act or phase C is completed, the method can automatically transition to act or phase D.

If the test is aborted, it can be made clear, for example, at which point the test was interrupted. After any necessary repairs, the method can then be restarted from the beginning with either act or phase A, act or phase B, or act or phase C. In one embodiment, the method is repeated from the beginning, starting with act or phase A.

Act or phase D is used to commission system 10 with AC and DC power, in which the power is gradually ramped up. Cycles and power lifts are provided for this purpose.

Initially, in a first act of phase D, the power converter 16 is started with a power limit, and its power gradually ramped up. Alternatively or in addition to heating with reactive power in act or phase B, act or phase D can be used to heat the power converter 16 through exchanged active power.

In the case of PV generators as DC units, for example, the power is naturally limited by irradiation and therefore there is no guarantee that sufficiently high power is available for heating in this act or phase D; therefore, in this case or embodiment, heating by means of reactive power as in act or phase B may be preferred.

In the case of, for example, batteries or electrolyzers as DC units, however, it is generally possible to effect the heating in a targeted manner by means of adjustable active power between 0 and the rated power of the power converter 16 in this act or phase D, so that heating by means of reactive power as in act or phase B could be omitted.

Specifically, in one embodiment the following times can be used for heating in act or phase D, especially for batteries as DC units:
The first 8 hours: 10-60% of the rated power of each power converter 16.
The second 8 hours: 10-80% of the rated power of each power converter 16, whereby a stop can be forced after approximately 4 hours in this process in order to obtain an additional heat-cold cycle.
After 16 hours, the test can be completed; if necessary, the times can be reduced, e.g., to be completed in one day/within one daylight period.

Act or phase D, for example, can be completed automatically. It is possible for act or phase D to be completed without any personnel being present at system 10. Once act or phase D is completed, the method can be terminated and system 10 can, for example, automatically transition to normal operation.

If the test is aborted, it can be made clear, for example, at which point the test was interrupted in one embodiment. After any necessary repairs, the method can then be restarted again from the beginning with act or phase A, act or phase B, act or phase C, or act or phase D. In one embodiment, the method is repeated from the beginning, starting with act or phase A.

In this act, additional operational control parameters are set such that, when subsequently restarted, the system will operate in normal mode.

All four phases of the method can be documented in one or more log files and can be identified as individual phases. As soon as the method is aborted, it can be made clear at which point the test was interrupted. This can also be marked accordingly in the log file in the log files.

What is claimed is:

1. A method for commissioning a system for electrical power conversion, which has at least one power converter with a DC intermediate circuit and a bridge circuit, wherein the system is connected on a DC side to at least one DC unit, and on an AC side to an AC grid, wherein the at least one power converter is connected to the at least one DC unit via at least one DC switch and to the AC grid via at least one AC switch, the method comprising:
establishing an auxiliary network for supplying power to components of the system in a first phase,
connecting the AC grid to the system and disconnecting the at least one DC unit from the system in a second phase, and
connecting the AC grid and the at least one DC unit to facilitate a power exchange between the AC grid and the at least one DC unit and testing the at least one power converter during the power exchange in a third phase.

2. The method of claim 1, wherein the first phase further comprises:
using a rectifier of the system in establishing the auxiliary network for supplying power to components of the system from the AC grid for powering an actuation of the at least one AC switch, the at least one DC switch and a sine filter capacitor contactor,
closing the at least one AC switch,
connecting a capacitor of an AC-side sine filter circuit via the sine filter capacitor contactor to the AC grid,
checking the power supplied from the auxiliary network and subsequently opening the at least one AC switch, and
continuing the method if the power supplied from the auxiliary network is within predetermined limits, or aborting the method if the power supplied from the auxiliary network is outside the predetermined limits.

3. The method according to claim 1, wherein the second phase further comprises:
pre-charging the DC intermediate circuit of the at least one power converter via a pre-charging circuit,
performing a self-test of the bridge circuit of the at least one power converter,
if the self-test is successful, connecting the AC grid to the at least one power converter by closing the at least one AC switch.

4. The method according to claim 1, wherein the second phase further comprises:
switching the bridge circuit of the at least one power converter to exchange electrical reactive power between the intermediate circuit and the AC grid.

5. The method according to claim 4, further comprising detecting a temperature in the bridge circuit of the power converter and increasing the temperature by adjusting the reactive power exchange or by controlling a fan of the system, or both, until the temperature in the bridge circuit of the power converter exceeds a predetermined lower threshold or reaches a predeterminable upper threshold, or both.

6. The method according to claim 5, wherein the lower threshold and the upper threshold have a temperature difference of at least 40 Kelvin and are repeatedly reached in alternation by controlling the reactive power exchange.

7. The method according to claim 1, wherein the third phase further comprises:
exchanging power between the AC side and the DC side of the system, detecting an exchanged AC power of at least one power converter and an exchanged DC power of the at least one power converter, and checking a plausibility of the detected exchanged AC power and exchanged DC power values.

8. The method according to claim 7, wherein the power exchange takes place at power levels between 5% and 20% of a rated power of the at least one power converter.

9. The method according to claim 1, the third phase further comprising:
with the AC grid connected and with several DC units connected in parallel on the DC side of the system,
detecting currents of the DC units connected in parallel and checking a symmetry of the detected currents.

10. The method according to claim 9, wherein detection of the currents is carried out at a minimum power of the DC units.

11. The method according to claim 1, wherein the third phase further comprises:
checking a fan or other sensors of the system.

12. The method according to claim 1, wherein the third phase further comprises:
exchanging power between the AC side and the DC side of the system, with the power exchange being increased in several stages.

13. The method according to claim 12, wherein the power exchange is increased in several stages between approximately 10% of a rated power of the system and 60% of the rated power of the system.

14. The method according to claim 12, wherein the power exchange is increased in several stages between approximately 10% of the rated power of the system and 80% of the rated power of the system.

15. The method according to claim 12, comprising:
when at least one predetermined temperature of the at least one power converter is reached for a predetermined period of time, terminating the method.

16. The method according to claim 1, wherein the at least one DC unit comprises at least one DC generator, a battery, or a load or a combination thereof.

17. A system for electrical power conversion, having at least one power converter with an intermediate circuit and a bridge circuit, wherein the system is connected on a DC side to at least one DC unit and on an AC side to an AC grid, wherein the at least one power converter is connected to the at least on DC unit via the at least one DC switch and to the AC grid via at least one AC switch, wherein the system comprises a control circuit configured to carry out the method according to claim 1.

18. The system according to claim 17, wherein the system comprises a sine filter capacitor contactor and an auxiliary network with an auxiliary network disconnector configured to connect the auxiliary network to the AC grid, wherein the sine filter capacitor contactor is functionally coupled to the auxiliary network disconnector.

19. The system according to claim 17, wherein the auxiliary network comprises a rectifier configured to provide a DC auxiliary voltage, wherein the functional coupling between the sine filter capacitor contactor and the auxiliary network disconnector is configured to maintain the DC auxiliary voltage at a predetermined quality level when the sine filter capacitor contactor is actuated.
